(19) United States
(12) Patent Application Publication
(10) Pub. No.: US 2023/0304352 A1
(43) Pub. Date: Sep. 28, 2023

(54) Adjustable Shim Assembly

(71) Applicants: Denis Friezner, Boise, ID (US); Cory Reisner, Northridge, CA (US)

(72) Inventors: Denis Friezner, Boise, ID (US); Cory Reisner, Northridge, CA (US)

(21) Appl. No.: 17/883,884

(22) Filed: Aug. 9, 2022

Related U.S. Application Data
(63) Continuation-in-part of application No. 17/701,343, filed on Mar. 22, 2022.

(51) Int. Cl. E06B 1/60

(52) U.S. Cl. CPC E06B 1/6069

(57) ABSTRACT

A method for using the shim assembly of the invention to install an opening closure in a building opening.

### CROSS-REFERENCE TO RELATED APPLICATIONS

This is a Continuation-in-Part Application of U.S. Serial No. 17/701,343 filed Mar. 22, 2022, which claims the benefit of co-pending Provisional Application No. 63/190,981 filed May 20, 2021.

### STATEMENT REGARDING FEDERALLY SPONSORED RESEARCH OR DEVELOPMENT: NOT APPLICABLE

### INCORPORATION-BY-REFERENCE OF MATERIAL SUBMITTED ON A COMPACT DISC: NOT APPLICABLE

### BACKGROUND OF THE INVENTION

### Field of the Invention

The present invention relates generally to shims of the character used in building construction to install fixtures such as windows, doors, and the like within rough framed openings.

### Description Of Related Art Including Information Disclosed Under 37 Cfr 1.97 And 1.98

In prior art building construction practice, rough framed openings are typically provided to accommodate the installation of prefabricated door and window units. It is well understood that the door and window units must be secured within the rough framed openings so that there is a gap between the exterior frame of the window or door and the rough framed opening. The gap surrounding the window or door must be sufficient so that any shifting of the opening frame does not compress the exterior frame of the window or door against the opening frame. In this way, loads that are generated by slight movements in the building frame are transferred around the window or door by way of the gap and do not pass through the window or door. If there were no such gap, a shifting load could compress the opening against the exterior frame of the window or door making it difficult to properly operate the window or door.

It is common in prior art building construction practice to place shims between the exterior frame of an insertable structure such as window or door and the rough framed opening of the building. Typically, the shims are used in pairs wherein each shim has a thick back end and a thin front end, a flat base surface and an opposed sloped contact surface extending between the ends. As a general rule, the gap distance between structural surfaces of the frames is more than one-quarter inch and less than one-half inch. A typical prior art wooden shim is about six to ten inches long, has about a one-sixteenth inch thin leading end and about a three-eighths inch thick back end, and is about one and a quarter inches wide. Such shims were often fabricated by the construction worker on the construction site from scrap materials. However, finding a shim of the appropriate size and shape to achieve the correct spacing is often difficult and time-consuming and if an incorrect shim is used, the installed window or door unit will be improperly positioned within the rough framed opening. It is this prior art drawback that the present invention seeks to overcome by providing an easily adjustable shim assembly that can readily be used by relatively unskilled workers to properly install prefabricated window and door units within rough framed openings.

### BRIEF SUMMARY OF THE INVENTION

By way of brief summary, the present invention comprises an adjustable shim assembly that includes a base, a fixed wedge connected to the base, the fixed wedge having a downwardly sloping upper surface provided with a multiplicity of spaced apart fixed wedge rails and an adjustable wedge connected to the fixed wedge for movement between a first position and a second position, the adjustable wedge having an upper surface and an upwardly sloping lower surface provided with a multiplicity of spaced apart track like channels configured to encircle and engage the fixed wedge rails.

With the forgoing in mind, it is a primary object of the invention to provide a shim assembly, the thickness of which can be quickly and easily incrementally changed by the worker.

Another object of the invention is to provide a shim assembly of the aforementioned character in which the base of the shim assembly can quickly and easily be extended through the use of a base extension that is slidably connected to the base of the assembly.

Another object of the invention is to provide a shim assembly of the character described in the preceding paragraphs in which the base of the shim assembly includes a mounting surface that is easily accessible by the workman to enable the assembly to be secured to the rough framed opening.

Yet another object of the invention is to provide an apparatus of the character described that is of a unique design and is suitable for use in various types of construction.

Still another object of the invention is to provide an apparatus as described in the preceding paragraphs that is of a durable metal construction and is virtually impervious to the elements.

A further object of the invention is to provide a method for using the shim assembly of the invention to install an opening closure in a building opening.

Another object of the invention is to provide a method for interconnecting an optional extension to the shim assembly of the invention.

Still another object of the invention is to provide a method for interconnecting a thermal break to the shim assembly of the invention.

Yet another object of the invention is to provide a method for positioning the shim assembly of the invention within a building opening and then overlaying the opening closure rail of the opening closure over the shim assembly.

### BRIEF DESCRIPTION OF SEVERAL VIEWS OF THE DRAWINGS

FIG. 1 is a generally perspective view of one form of the shim assembly of the invention.

FIG. 2 is a generally perspective exploded view of the shim assembly illustrated in FIG. 1 when positioned proximate a portion of a frame opening.

FIG. 3 is a generally perspective top view of the base of the shim assembly illustrated in FIG. 1.

FIG. 4 is a generally perspective top view of the base extension of the shim assembly illustrated in FIG. 1.

FIG. 5 is a generally perspective top view of the fixed wedge component of the shim assembly illustrated in FIG. 1.

FIG. 6 is a side elevational view of the fixed wedge component of the shim assembly shown in FIG. 5.

FIG. 7 is a generally perspective, exploded view illustrating the manner of slidably interconnecting the base extension component with the base of the shim assembly.

FIG. 8 is a generally perspective, exploded view illustrating the manner of slidably interconnecting the fixed wedge component with the base extension of the shim assembly.

FIG. 9 is a generally perspective, exploded view illustrating the manner of slidably interconnecting the fixed wedge component with the base of the shim assembly.

FIG. 10 is a generally perspective view illustrating the fixed wedge component as it appears when operably interconnected with the base of the shim assembly.

FIG. 11 is a side view illustrating the adjustable wedge component as it appears when operably interconnected with the fixed wedge component of the shim assembly.

FIG. 11A is a generally side view similar to FIG. 11 illustrating the adjustable wedge component as it appears when in an advanced position relative to the fixed wedge component of the shim assembly.

FIG. 11B is a view similar to FIG. 11A illustrating the adjustable wedge component as it appears in a further advanced position relative to the fixed wedge component of the shim assembly.

FIG. 12 is a generally perspective, exploded view illustrating the first accomplishment in carrying out the first step in the method of the invention, namely positioning the base plate above the sill pan.

FIG. 13 is a generally perspective view similar to FIG. 12 illustrating the second accomplishment in carrying out the first step in the method of the invention, namely positioning the base plate in engagement with the sill pan.

FIG. 14 is a generally perspective, exploded view similar to FIG. 13 illustrating the third accomplishment in carrying out the first step in the method of the invention, namely positioning the anchor bolts above the base plate.

FIG. 15 is a generally perspective view similar to FIG. 14 illustrating the fourth accomplishment in carrying out the first step in the method of the invention, namely using the anchor bolts to affix the base plate to the sill pan to form a first step assemblage comprising a sill pan, base plate and a plurality of anchor bolts.

FIG. 15A is a generally perspective view similar to FIG. 15 illustrating the fifth accomplishment in carrying out the first step in the method of the invention, namely affixing a plurality of base plate/anchor bolt assemblies to the sill pan at 8 inch spaced apart locations.

FIG. 16 is a generally perspective, exploded view illustrating the first accomplishment in carrying out the second step in the method of the invention, namely positioning a selected fixed wedge proximate a selected one of the sill pan, base plate, anchor bolt assemblies with the track like channels of the fixed wedge in alignment with the rails of the base plate.

FIG. 17 is a generally perspective view similar to FIG. 16 illustrating the second accomplishment in carrying out the second step in the method of the invention, namely sliding the fixed wedge inwardly along the rails.

FIG. 18 is a generally perspective view similar to FIG. 17 illustrating the third accomplishment in carrying out the second step in the method of the invention, namely positioning a connecter proximate the fixed wedge.

FIG. 19 is a generally perspective view similar to FIG. 18 illustrating the fourth accomplishment in carrying out the second step in the method of the invention, namely using the connecter, connecting the fixed wedge to the base plate.

FIG. 20 is a generally perspective, exploded view illustrating the first accomplishment in carrying out the third step in the method of the invention, namely positioning a selected adjustable wedge proximate a selected one of the base plate/fixed wedge assemblies with the track like channels of the adjustable wedge in alignment with selected fixed wedge rails of the fixed wedge.

FIG. 21 is a generally perspective view similar to FIG. 20 illustrating the second accomplishment in carrying out the third step in the method of the invention, namely sliding the adjustable wedge inwardly along the selected fixed wedge rails.

FIG. 22 is a side elevational view similar FIG. 21 further illustrating the second accomplishment in carrying out the third step in the method of the invention, namely positioning the adjustable wedge relative to the fixed wedge.

FIG. 23 is a generally perspective view similar to FIG. 22 illustrating the first accomplishment in carrying out the fourth step in the method of the invention, namely repositioning the adjustable wedge relative to the fixed wedge to increase the thickness of the shim assembly.

FIG. 24 is a is a side elevational view similar to FIG. 23 further illustrating the first accomplishment in carrying out the fourth step in the method of the invention, namely repositioning the adjustable wedge relative to the fixed wedge to further increase the thickness of the shim assembly.

FIG. 25 is a generally perspective, exploded bottom view illustrating the first accomplishment in carrying out the fifth step in the method of the invention, namely positioning a selected extension proximate a selected one of the shim assemblies in a manner such that the rails of the extension are in alignment with the track like channels of the adjustable wedge of the shim assembly.

FIG. 26 is a generally perspective, exploded top view further illustrating the first accomplishment in carrying out the sixth step in the method of the invention, namely positioning a selected extension proximate a selected one of the shim assemblies with the track like channels of the adjustable wedge of the shim assembly in alignment with the rails of the extension.

FIG. 27 is a generally perspective view similar to FIG. 26 illustrating the second accomplishment in carrying out the sixth step in the method of the invention, namely positioning the extension on the adjustable wedge of the shim assembly.

FIG. 28 is a generally perspective view similar to FIG. 27 illustrating the third accomplishment in carrying out the sixth step in the method of the invention, namely using the connecter, connecting the extension to the shim assembly.

FIG. 29 is a side view similar to FIG. 28 further illustrating the third accomplishment and showing the increase in height of the shim assembly/ extension assembly.

FIG. 30 is a generally perspective, exploded bottom view illustrating the first accomplishment in carrying out the seventh step in the method of the invention, namely positioning a selected thermal break proximate a selected one of the shim assembly/extension assemblies with the rails of the thermal break in alignment with the track like channels of the extension.

FIG. 3 1 is a generally perspective, exploded top view further illustrating the first accomplishment in carrying out the seventh step in the method of the invention, namely positioning the thermal break proximate a selected one of the shim assembly/extension assemblies with the rails of the thermal break in alignment with the track like channels of the extension.

FIG. 32 is a generally perspective view similar to FIG. 31 illustrating the second accomplishment in carrying out the seventh step in the method of the invention, namely positioning the thermal break on the extension to form the shim assembly/extension/thermal break assemblage of the invention.

FIG. 33 is a side view similar to FIG. 32 further illustrating the second accomplishment and showing the increase in height of the shim assembly/ extension/ thermal break assembly.

FIG. 34 is a generally perspective view illustrating the first accomplishment in carrying out the eighth step in the method of the invention, namely positioning a closure rail on the thermal break.

FIG. 35 is a side view similar to FIG. 34 further illustrating the first accomplishment in carrying out the eighth step in the method of the invention, namely positioning a closure rail on the thermal break.

FIG. 36 is a greatly enlarged, generally perspective, cross-sectional view similar to FIG. 34 illustrating the second accomplishment in carrying out the eighth step in the method of the invention, namely positioning a closure rail on the thermal breaks of selected spaced apart shim assembly/extension/thermal break assemblages of the invention.

### DETAILED DESCRIPTION OF THE INVENTION

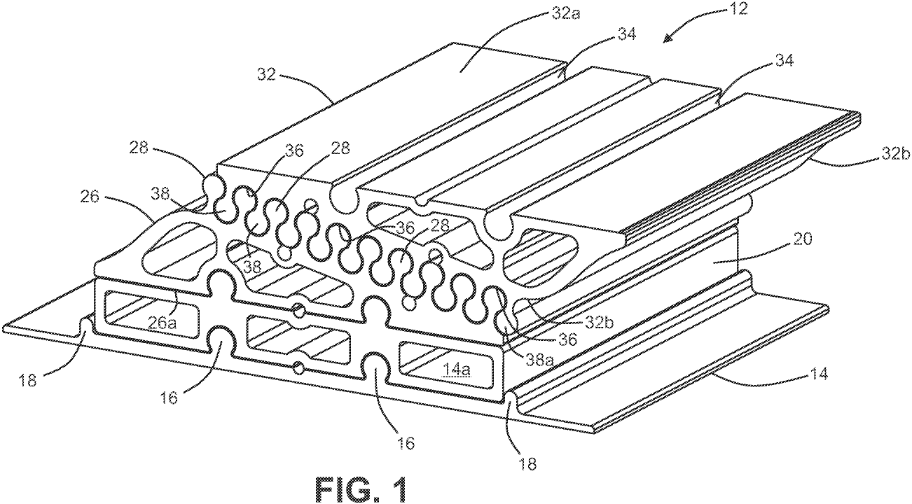

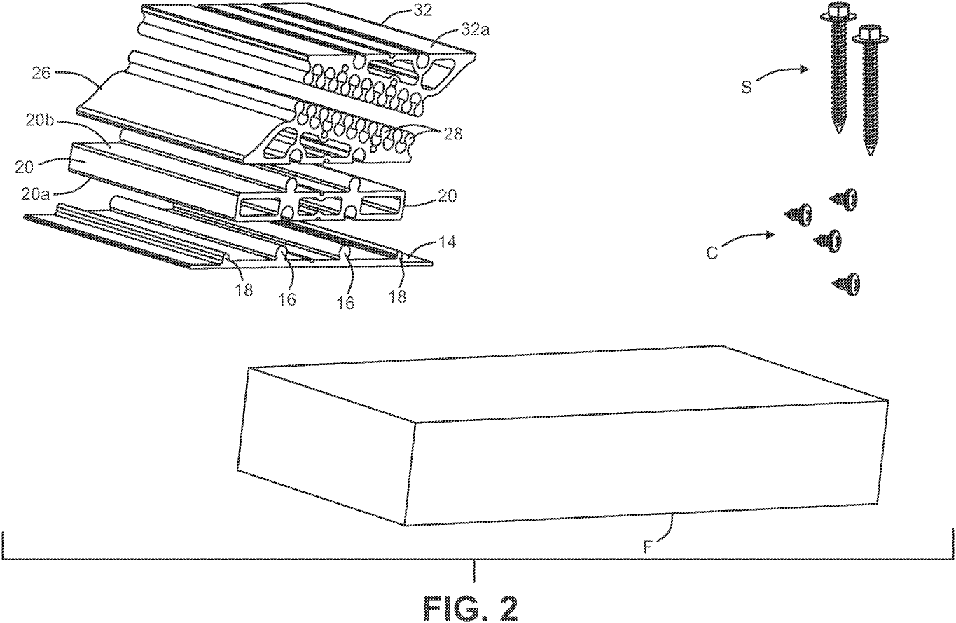

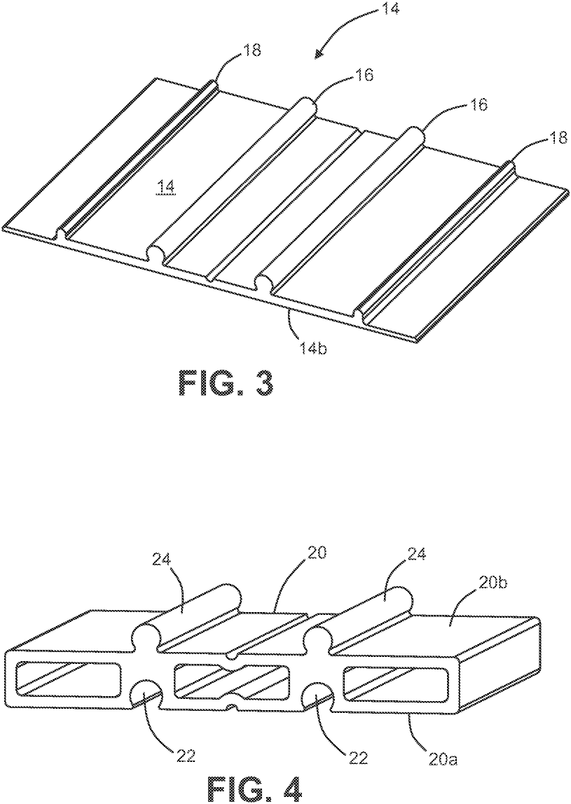

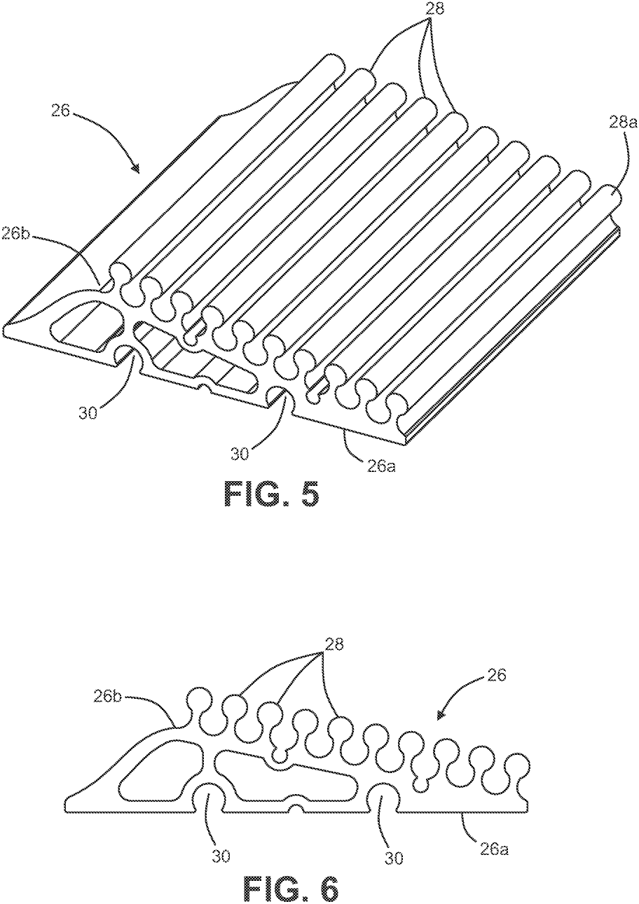

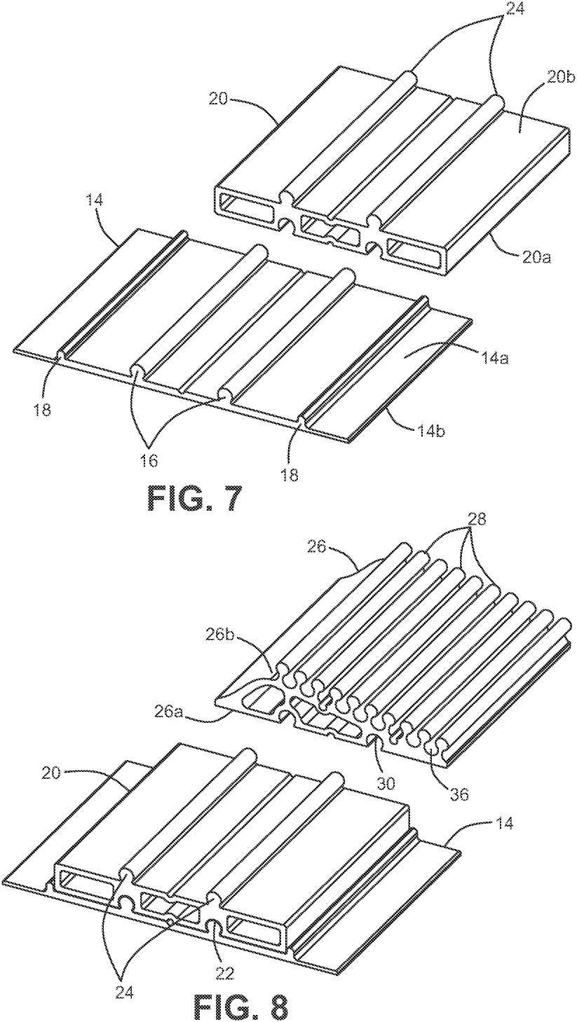

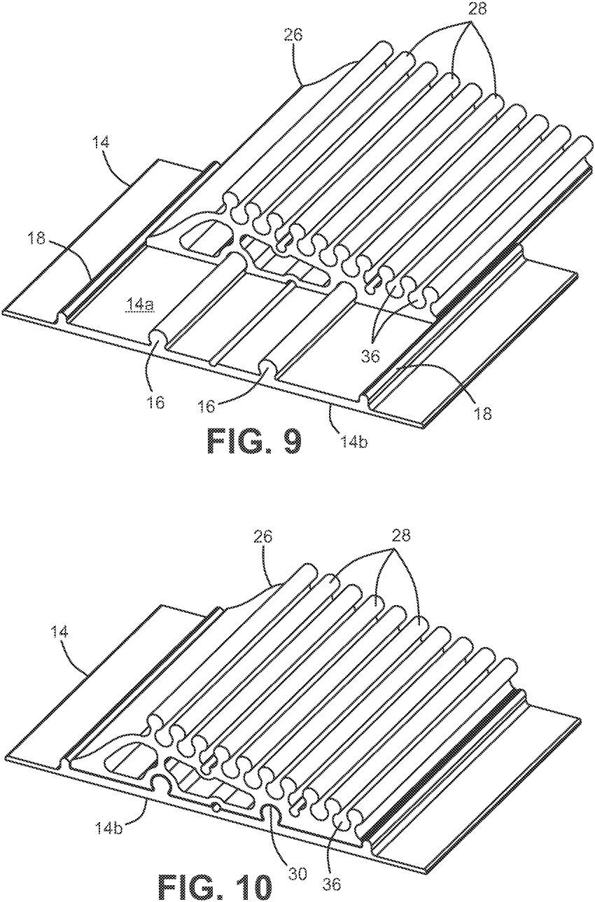

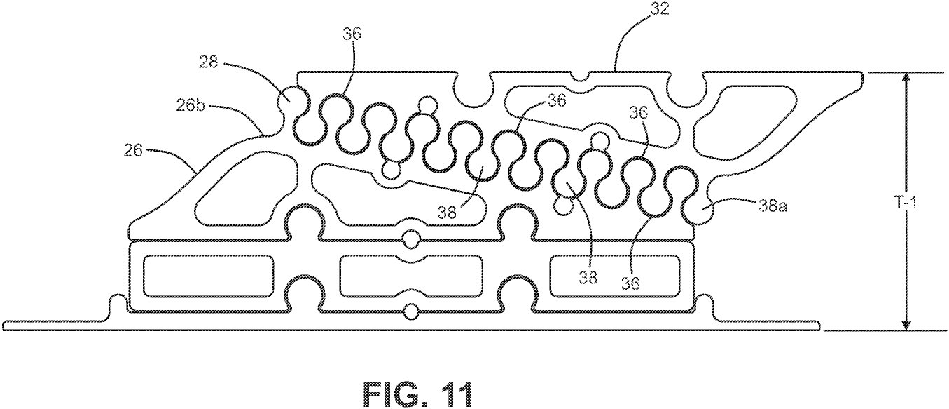

Referring to the drawings and particularly to FIGS. 1 and 2, one form of the present invention can be seen to comprise an adjustable shim assembly generally designated by the numeral 12. Assembly 12 here comprises a base 14 having an upper surface 14a and a lower surface 14b. Provided on upper surface 14a is a plurality of spaced apart base rails 16 and a plurality of spaced apart guides 18. Slidably connected to base 14 for movement between a first position and a second position is a base extension 20 that has a lower surface 20a and an upper surface 20b. Lower surface 20a is provided with a plurality of spaced apart track like channels 22 and upper surface 20b is provided with a plurality of spaced apart base extension rails 24 (FIG. 4). Slidably connected to base extension 20 for movement between a first position to a second position is a first, or fixed wedge 26. As best seen in FIGS. 5 and 6 of the drawings, fixed wedge 26 has a lower surface 26a and a downwardly sloping upper surface 26b that is provided with a plurality of spaced apart fixed wedge rails 28. Lower surface 26b is provided with a plurality of track like channels 30 that are configured and arranged to encircle and strategically engage the base extension rails 24 (FIG. 5). Slidably connected to fixed wedge 26 for movement between a first position and a second position is a second, or adjustable wedge 32. Second wedge 32 has an upper surface 32a provided with spaced apart track like channels 34 and a downwardly sloping lower surface 32b provided with a multiplicity of spaced apart track like channels 36 that are configured to encircle and strategically engage fixed wedge rails 28. Lower surface 32b of adjustable wedge 32 is also provided with a multiplicity of spaced apart rails 38 (FIG. 1),

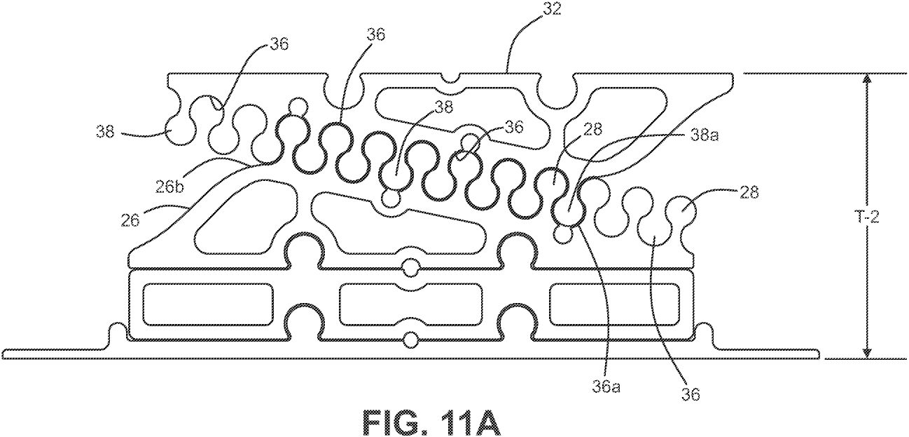

Referring to FIGS. 11, 11A and 11B, one method of the invention for incrementally adjusting the thickness of the shim assembly is there illustrated. FIG. 11 illustrates the starting position of the shim assembly wherein the thickness of the assembly is designated as “T-1”. FIG. 11A illustrates an adjustment of the shim assembly in a manner to increase the thickness of the shim to “T-2”. This adjustment is accomplished by slidably removing the adjustable wedge 32 from the fixed wedge 26 and then repositioning the adjustable wedge by slidably interconnecting it to the fixed wedge at a location upwardly of the sloping surface 26b. More particularly, in this position the rail designated as 38a in FIG. 11 is moved from the position shown in FIG. 11 to the position shown in FIG. 11A wherein it is received within the channel designated as 36a. FIG. 11B illustrates a further adjustment of the shim assembly in a manner to increase its thickness to “T-3”. This adjustment is accomplished by once again slidably removing the adjustable wedge 32 from the fixed wedge 26 and then reconnecting it to the fixed wedge at a location further upwardly of the sloping surface 26b. More particularly, in this position the rail designated as 38a in FIG. 11 is moved from the position shown in FIG. 11A to the position shown in FIG. 11B wherein it is received within the channel designated as 36b. It is to be understood that the starting thickness T-1 can be varied depending upon the work to be accomplished. Similarly, the integrals of adjustment of the thickness of the shim assembly can be varied depending on the work to be accomplished. However, experience has shown adjustment of the thickness of the shim assembly by increments of 1/16 of an inch has proven satisfactory for most undertakings.

In in accordance with one method of the invention for adjusting distances between an exterior frame of an insertable structure and an opening frame of a building, at least two of the shim assemblies of the invention are placed upon spaced apart portions of the bottom of the opening frame “F” (FIG. 2). Next, a level is placed across the shim assemblies to determine which of the shim assemblies must be adjusted to level the insertable structure. Once this is determined, and after the appropriate threaded connectors “C” (FIG. 2) that function to interconnect the various components of the shim assembly have been removed, the adjustable wedge 32 of the selected shim assembly is slidably removed from fixed wedge 26 of the selected shim assembly. This done, the adjustable wedge is slidably reconnected to the fixed wedge at a location spaced apart from the starting position shown in FIG. 11 where the shim thickness is “T-1”, to an advanced position such as the position shown in FIG. 11A where the shim thickness is increased to “T-2”. Using appropriate connectors, such as screws “S” (FIG. 2), the pairs of shims are then secured to the sill.

In a similar manner, at least two of the shim assemblies of the invention are placed upon spaced apart portions of the opposed vertical sides of the opening frame of the structure as well as upon spaced apart portions of the top of the opening frame. Typically, the shims are inserted from opposing sides of the insertable structure and held in place temporarily by friction between side and top structural surfaces of the opening frame of the building and the exterior frame of the window or door. Next, the thickness of the shims is adjusted incrementally in the manner described in the preceding paragraphs to change the thickness of the shims as necessary to bring the insertable structure into plumb. More particularly, in order to change the thickness of a given shim, the adjustable wedge 32 of the shim is slidably removed from fixed wedge 26 and appropriately repositioned on the fixed shim in the manner previously described. When the shim assemblies are adjusted so that the insertable structure is plumb and square, the shims are secured, such as by screws “S” (FIG. 2), to the frame structure of the opening frame.

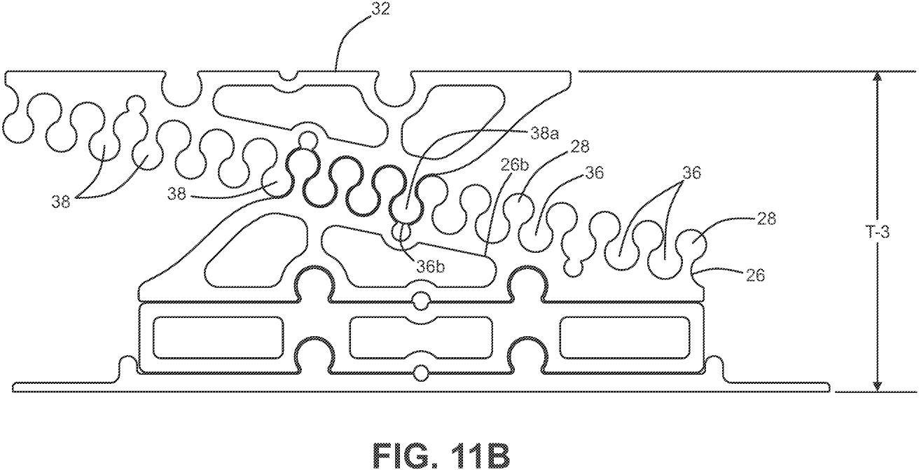

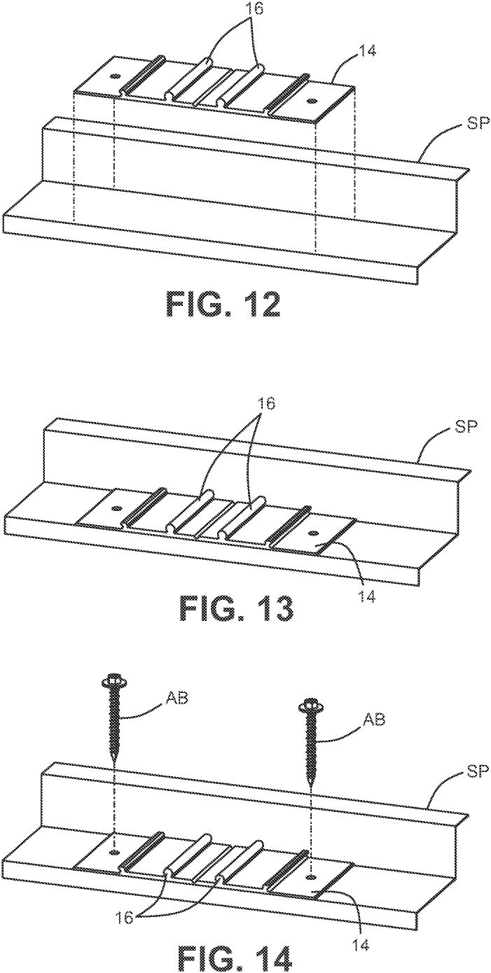

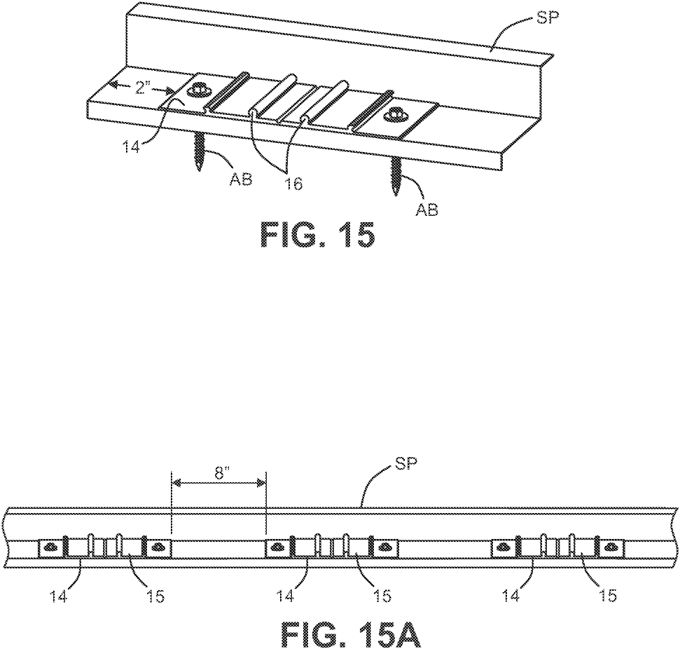

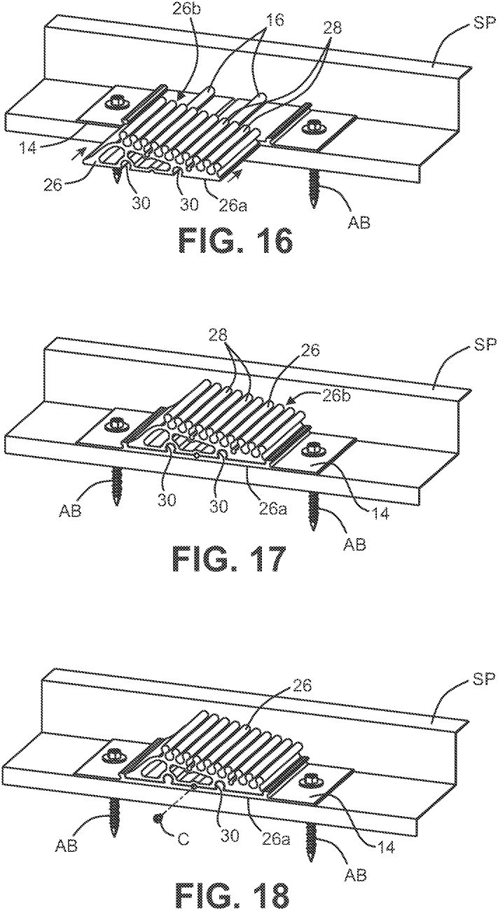

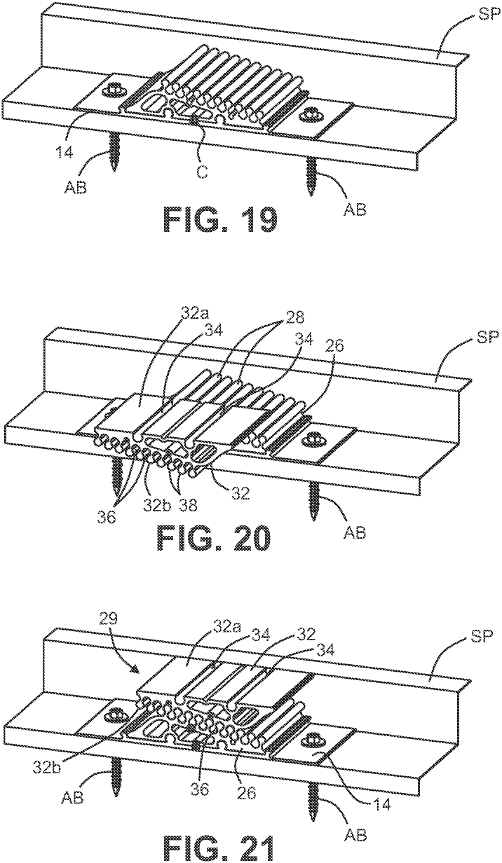

Referring now to FIGS. 12 - 36, still another form of the invention is there illustrated. This form of the invention concerns the method of using the shim assembly of the invention in the installation of a closure, such as a window or a door, within a building structure opening. As illustrated in FIGS. 12-15 of the drawings, the first step in the method of the present invention is the affixation of base plate 14 to the sill pan “SP” that is located within the building structure opening. As will be apparent from the discussion which follows, this first step is achieved through various sequential accomplishments. For example, in carrying out the first step of the method of the invention, the first accomplishment involves positioning the base plate above the sill pan in the manner shown in FIG. 12. This done, the next accomplishment involves placing the base plate on the sill plate in the manner shown in FIGS. 13, 14 and 15 so that it is located about two inches from the end of the opening (see FIG. 15). Next, as illustrated in FIG. 15, the base plate is secured in place by appropriate anchor bolts “AB”. This done, additional base plates are affixed to the sill pan at a spacing of approximately eight inches edge to edge (see FIG. 15A). At this point, if deemed necessary, an appropriate waterproofing liquid is applied to the base plates to form a plurality of waterproof plates 15.

The next, or second step in the method of the invention, which is also achieved through various sequential accomplishments, involves the interconnection of fixed wedge 26 to a selected one of the base plates 15 in the manner illustrated in FIGS. 16 - 19. In this regard, as previously discussed herein, fixed wedge 26 is provided with a plurality of track like channels 30 that are configured and arranged to encircle and strategically engage base plate rails 16. Therefore, in accordance with the second step of the method of the present invention, with a selected fixed wedge positioned proximate a selected base plate/sill pan assembly in the manner shown in FIG. 16, the fixed wedge is slidably urged inwardly along rails 16 to the position shown in FIG. 17. This done, the wedge is secured to the base plate using connector “C” (FIG. 18).

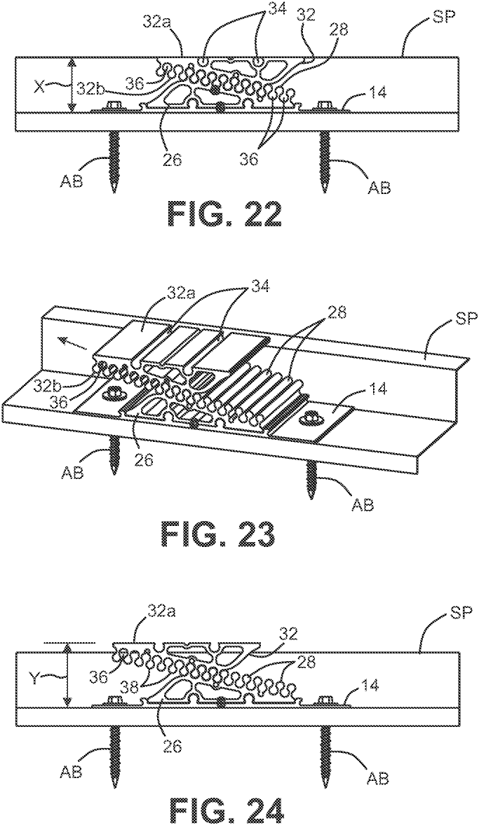

The next, or third step in the method of the invention, which is illustrated in FIGS. 20, 21 and 22 concerns the mating of the adjustable wedge 32 with the fixed wedge 26. As illustrated in the drawings, adjustable wedge 32 has an upper surface 32a provided with spaced apart track like channels 34 and a downwardly sloping lower surface 32b provided with a multiplicity of spaced apart track like channels 36 that are configured to encircle and strategically engage fixed wedge rails 28. Lower surface 32b of adjustable wedge 32 is also provided with a multiplicity of spaced apart rails 38 (see also FIG. 11). Therefore, in accordance with the third step of the method of the present invention, with a selected adjustable wedge positioned proximate a selected fixed wedge in the manner shown in FIG. 20, the adjustable wedge is slidably urged inwardly along rails 28 to the position shown in FIGS. 21 and 22 to form a basic wedge 29.

The next, or optional fourth step in the method of the invention, which is illustrated in FIGS. 23 and 24, concerns the modification of the basic shim 29 by repositioning the adjustable wedge relative to the fixed wedge to increase the height, or thickness of the shim assembly. It is to be understood that the size of the shim assembly, including the height, or thickness of the assembly depends upon the job to be performed. By way of example, the thickness of the shim assembly shown in FIG. 11 of the drawings is on the order of 1¼ inches which is the lowest possible thickness of this shim assembly there shown. Similarly, the integrals of adjustment of the thickness of the basic shim assembly can be varied from job to job. However, as previously mentioned, experience has shown adjustment of the thickness of the shim assembly by increments of 1/16 of an inch has proven satisfactory for most undertakings. To adjust the thickness of the basic shim assembly in accordance with one form of the method of the present invention, the adjustable wedge is removed from the fixed wedge and sequentially moved upwardly from rail to rail along the downwardly sloping surface of the fixed wedge. Such movement of the adjustable wedge from rail to rail permits adjustment of the thickness of the shim assembly by about 1/16 of an inch making the maximum adjustable thickness of the assembly to be on the order of 1¾ inch.

With this in mind, and by way of further clarification, this fourth step of the method of the invention is accomplished by moving the adjustable wedge upwardly of the sloping surface 26b from the position shown in FIGS. 21 and 22 where the thickness of the shim assembly is X, to the position shown in FIGS. 23 and 24 where the thickness of the shim assembly is Y.

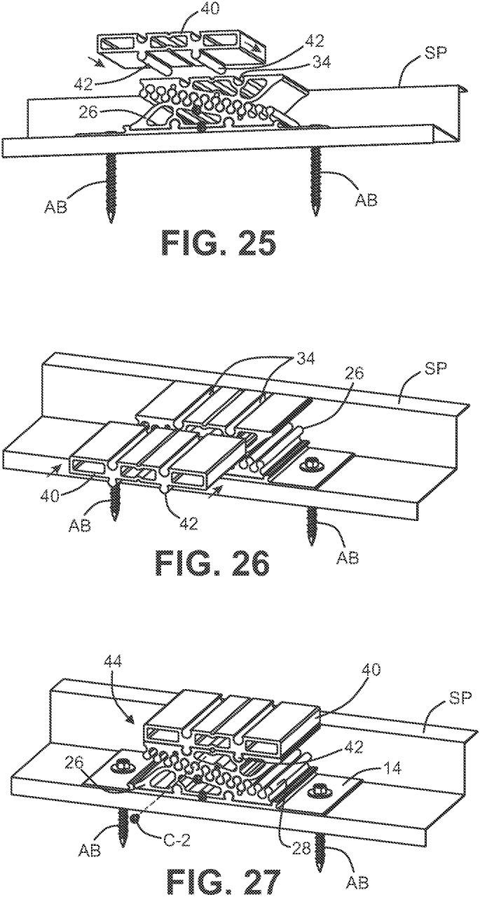

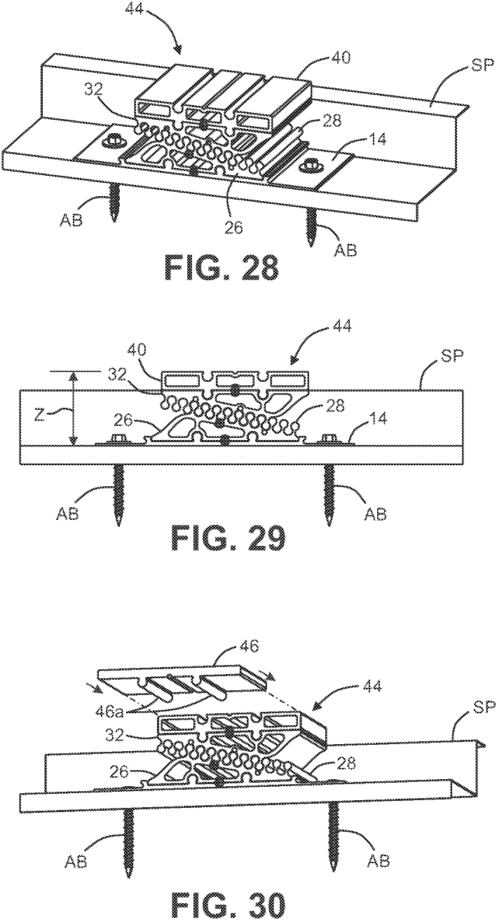

The fifth optional step in the method of the invention for increasing the thickness of the shim assembly concerns installing an optional ½ inch extension 40 to the basic shim assemblies in the manner illustrated in FIGS. 25, 26 and 27. The first accomplishment in this fifth step of the invention involves the positioning of the selected extension at a location proximate a selected one of the shim assemblies. As illustrated in FIGS. 25 and 26, the selected extension is positioned in a manner such that the rails 42 of the extension are in alignment with the track like channels 34 of the adjustable wedge of the shim assembly (see FIGS. 25 and 26). With the selected extension positioned in a manner shown in FIGS. 25 and 26, the second accomplishment in this fifth step of the invention consists of sliding the extension inwardly along the track like channels 34 to the position shown in FIG. 27. This done, the third accomplishment in this fifth step of the invention consists of connecting the extension to the shim assembly using connecter C-2 so as to create a shim/extension assembly 44 having a thickness “Z” (FIG. 29).

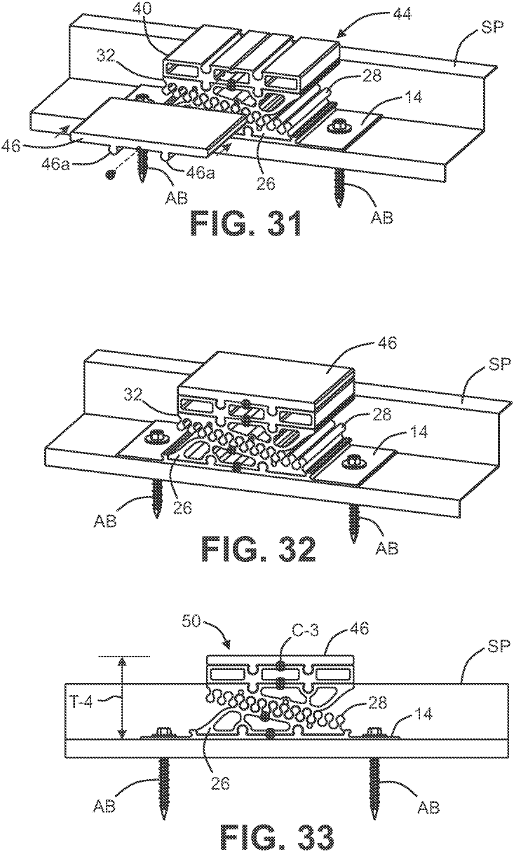

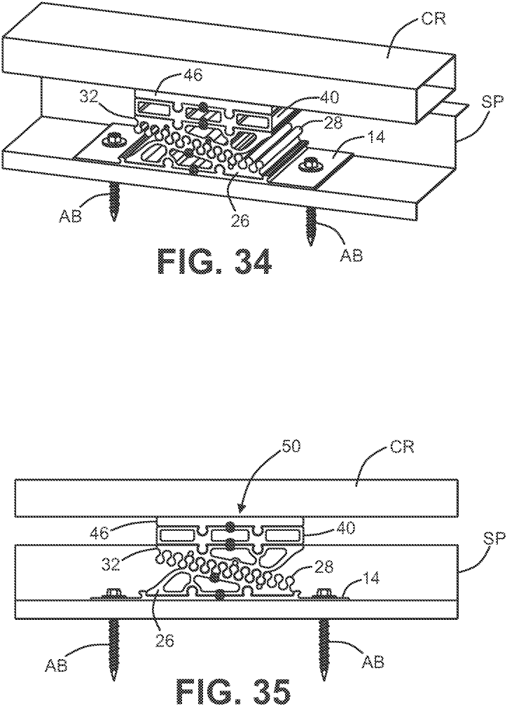

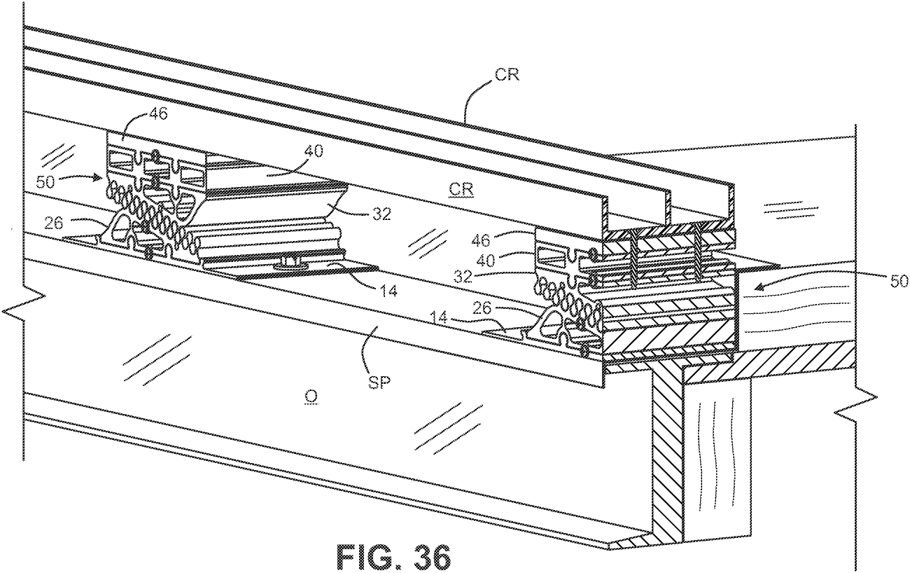

The sixth optional step in one form of the method of the invention concerns installing an optional thermal break 46 to the shim assemblies in the manner illustrated in FIGS. 30, 31, 32 and 33. FIG. 30 is a generally perspective, exploded bottom view illustrating the first accomplishment in carrying out the sixth step in the method of the invention, namely positioning an optional thermal break 46 proximate a selected one of the shim/extension assemblies 44 with the rails 46a of the optional thermal break extension in alignment with track like channels of the extension of the shim/extension assembly. FIG. 31 is a generally perspective, exploded top view further illustrating and showing the increase in height of the shim assembly/extension/thermal break assembly.

FIG. 32 is a generally perspective, exploded view similar to FIG. 31 illustrating the second accomplishment in carrying out the sixth step in the method of the invention, namely sliding the optional thermal break 46 inwardly along the track like channels of the extension of the shim/extension assembly.

FIG. 33 is a generally perspective view similar to FIG. 32 illustrating the third accomplishment in carrying out the sixth step in the method of the invention, namely, using the connecter C-3, connecting the optional thermal break 46 to the extension of the shim/extension assembly to form the shim assembly/extension/thermal break assembly 50 and also showing the increase in thickness T-4 of the assembly.

The seventh step in the method of the invention concerns installing an opening closure such as a window, or door in a building opening “O” (FIG. 35). FIGS. 34, 35 and 36 illustrate one form of this method of the invention for adjusting distances between the opening closure and the building opening. The first accomplishment in the seventh step in the method of the invention, concerns positioning the opening closure rail “CR” over a selected shim assembly, such as shim assembly 50 (FIG. 35). The second accomplishment involves the use of a measuring tape to check the distance between the opening closure rail “CR” and the top of the building opening to verify the correct thickness of the shim assembly. This done, the third accomplishment in the seventh step of the invention involves placing at least two selected shim assemblies of the invention at spaced apart locations along the bottom of the opening frame (see FIG. 36). This done, the fourth accomplishment involves placing a level across the shim assemblies to determine which, if either of the shim assemblies must be adjusted to level the opening closure. Once this is determined, the building opening is closed by positioning the opening closure over the opening closure rail CR.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A method for installing an opening closure in a building opening using the shim assembly of the invention, said shim assembly including a base plate, a fixed wedge and an adjustable wedge, said method comprising the steps of:
(a) positioning the base plate within the building opening;
(b) affixing the fixed wedge to the base plate;
(c) slidably affixing the adjustable wedge to the fixed wedge for movement between a first position to a second position; and
(d) placing the opening closure onto the adjustable wedge.

2. The method as defined in claim 1 in which the building opening includes a sill and in which the method of the invention includes the further step of affixing the base plate to the sill.

3. The method as defined in claim 1 further including the step of affixing an extension to the adjustable wedge.

4. The method as defined in claim 3 further including the step of affixing a thermal break to the extension.

5. A method for installing an opening closure in a building opening using the shim assembly of the invention, said shim assembly including a base plate, a fixed wedge and an adjustable wedge, said method comprising the steps of:
(a) affixing a first fixed wedge to a first base plate;
(b) affixing a first adjustable wedge to said first fixed wedge to form a first shim assembly;
(c) positioning said first shim assembly within the building opening;
(d) affixing a second fixed wedge to a second base plate;
(e) affixing a second adjustable wedge to said second fixed wedge to form a second shim assembly;
(f) positioning said first shim assembly within the building opening;
(g) positioning said second shim assembly within the building opening proximate said first shim assembly; and
(h) placing the opening closure over said first and second shim assemblies.

6. A method for installing an opening closure in a building opening using the shim assembly of the invention, said shim assembly including a base plate, a fixed wedge having a downwardly sloping upper surface that is provided with a plurality of track like channels and an adjustable wedge having a downwardly sloping lower surface provided with a multiplicity of spaced apart rails, said method comprising the steps of:
(a) affixing the fixed wedge to the base plate;
(b) affixing the adjustable wedge to said fixed wedge at a first location along said downwardly sloping upper surface of said fixed wedge to form a shim assembly having a first thickness; and
(c) positioning said first shim assembly within the building opening.

7. The method as defined in claim 6 further including the step of removing the adjustable wedge from the first location along said downwardly sloping upper surface of said fixed wedge and repositioning the adjustable wedge at a second location along said downwardly sloping upper surface of said fixed wedge to form a shim assembly having a second thickness.
